(19) United States
(12) Patent Application Publication
(10) Pub. No.: US 2016/0227913 A1
(43) Pub. Date: Aug. 11, 2016

(54) ANTLER SHED ATTACHMENT DEVICE AND GARMENT FOR USE

(71) Applicants: Edward Gregory Odendahl, Brook Park, MN (US); Kelsey Ann Odendahl, Brook Park, MN (US)

(72) Inventors: Edward Gregory Odendahl, Brook Park, MN (US); Kelsey Ann Odendahl, Brook Park, MN (US)

(21) Appl. No.: 15/018,417

(22) Filed: Feb. 8, 2016

Related U.S. Application Data
(60) Provisional application No. 62/113,911, filed on Feb. 9, 2015.

(51) Int. Cl. A45F 5/02; A01M 31/00

(52) U.S. Cl. CPC A45F 5/021; A01M 31/006

(57) ABSTRACT

An anther shed attachment device is disclosed. The device includes a main strap and a plurality of loops including a clasping member. The clasping member allows for the attachment of shed antlers and the loops allow for movement along the main strap. Accordingly, a user is able to easily retain sheds within the clasp and along the strap for easy carrying.

### CROSS REFERENCE TO RELATED APPLICATIONS

This application claims priority to U.S. Provisional Patent Application No. 62/113,911 filed 9 Feb. 2015 to the above named inventors, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present invention relates to a strap for the attachment of antler sheds to retain them during transport.

### BACKGROUND OF THE INVENTION

The activity of shed hunting is growing in popularity and has quickly become a favorite activity of many an individual. Shed hunting, as it referred to in this application, is the process of searching for and finding antlers that have been shed from an animal. These shed antlers are commonly referred to as “sheds”. Typically, in shed hunting, an individual will utilize their knowledge, skill, and ability to track an animal to identify potential locations of these shed antlers. Additionally, an individual may utilize a dog or other domesticated animal to aid in this search of sheds. After these sheds are found, the individual will carry them from the area.

In the event that multiple sheds are found, it can be difficult to carry these sheds out of the search area as sheds often vary in width, length, girth, number of points, and other dimensional characteristics. Currently there exists no universal system for the affixation of sheds to an individual or backpack carried by the individual. Therefore, there is a need for a device that allows the individual to wear allowing for the attachment of various sheds. Preferably, this device allows the user flexibility in the attachment, location, and size of sheds that can be retained. Further, it is desired that this device is durable, easily used, and applicable in any weather condition.

### SUMMARY OF THE INVENTION

The shed attachment device of the present invention is designed to allow for the universal affixation of shed antlers. The shed attachment device of the present invention is adapted to be worn by a user as a specifically designed harness or strap member for the placement and attachment of shed antlers. This device can be provided in a standalone harness or strap member or affixed as an integrated accessory to a garment.

The device includes a main strap. The main strap has a width, a first end, and a second end opposite the first end, the distance between the first end and the second end defining a length of the main strap. The first end and the second end include a buckle, the buckle allowing for the adjustment of the length of the main strap and allowing for the attachment of the main strap to a user, a garment, a backpack, or a backpack frame. A plurality of loops are movably received around the width of the main strap. The loops include a clasp portion. The clasp portion being adjustable to affix various circumferences and dimensions of sheds. In use, a user will secure a shed within the clasp portion and move the loops to the desired position along the strap length for transport.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a front side view of a shed-retaining device, according to the present invention;

FIG. 2 is a rear view of the shed-retaining device, according to the present invention;

FIG. 3 is a front side view of a garment with the shed-retaining device affixed, according to the present invention;

FIG. 4 is a rear side view of the garment with the shed-retaining device, according to the present invention;

FIG. 5 is a side view of the garment with the shed-retaining device, according to the present invention;

FIG. 6 is a rear side view of the garment with the shed-retaining device in use, according to the present invention; and

FIG. 7 is an isometric view of the shed-retaining device, according to the present invention.

### DETAILED DESCRIPTION OF THE INVENTION

The following detailed description includes references to the accompanying drawing, which forms a part of the detailed description. The drawing shows, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

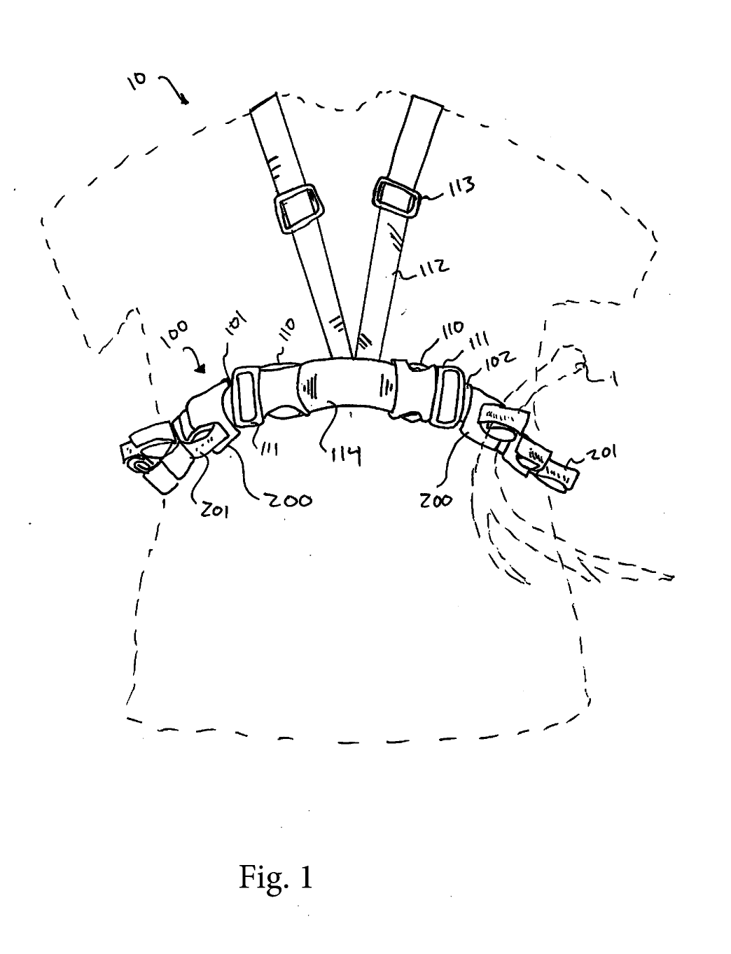

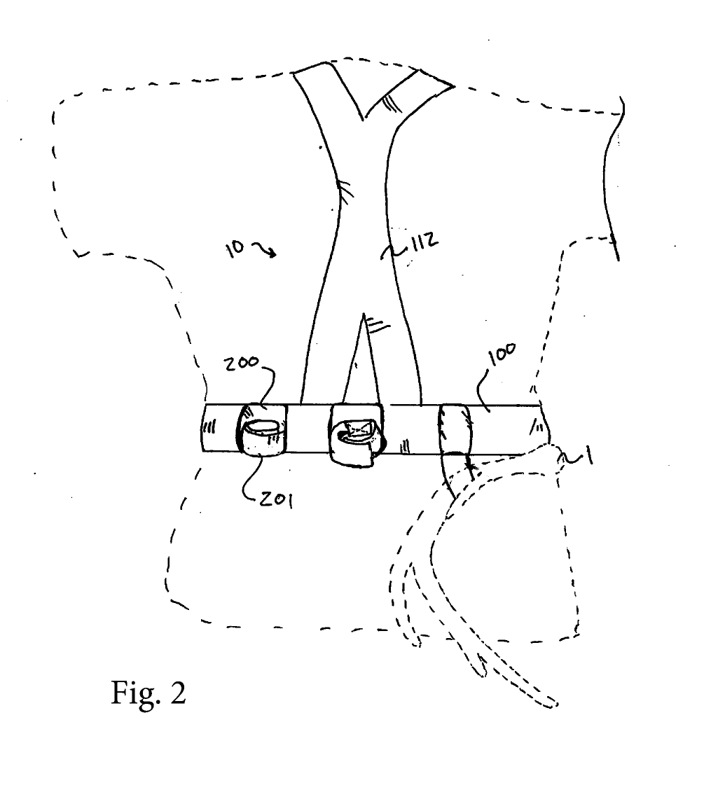

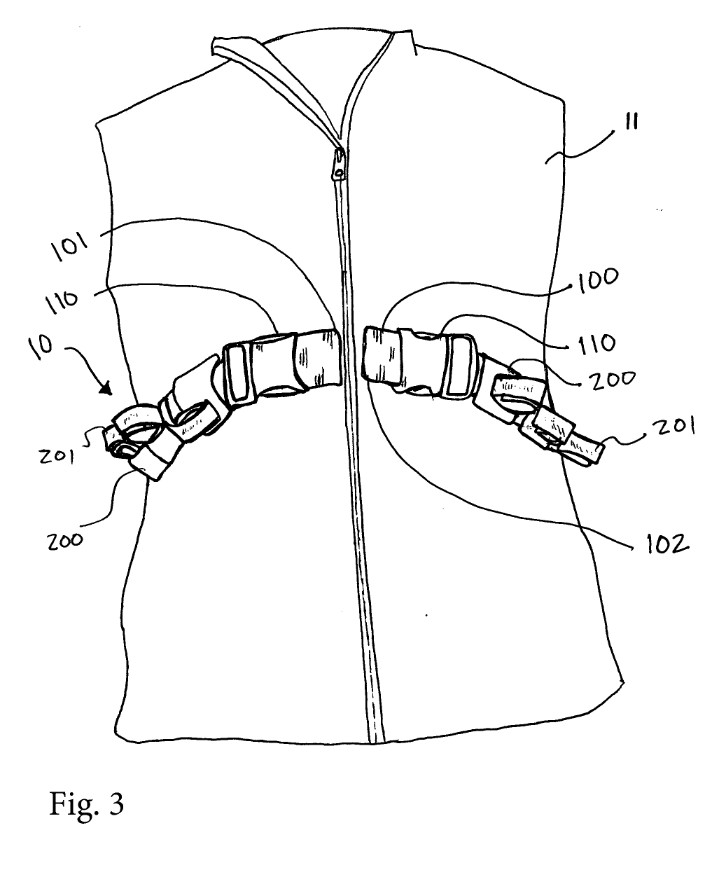

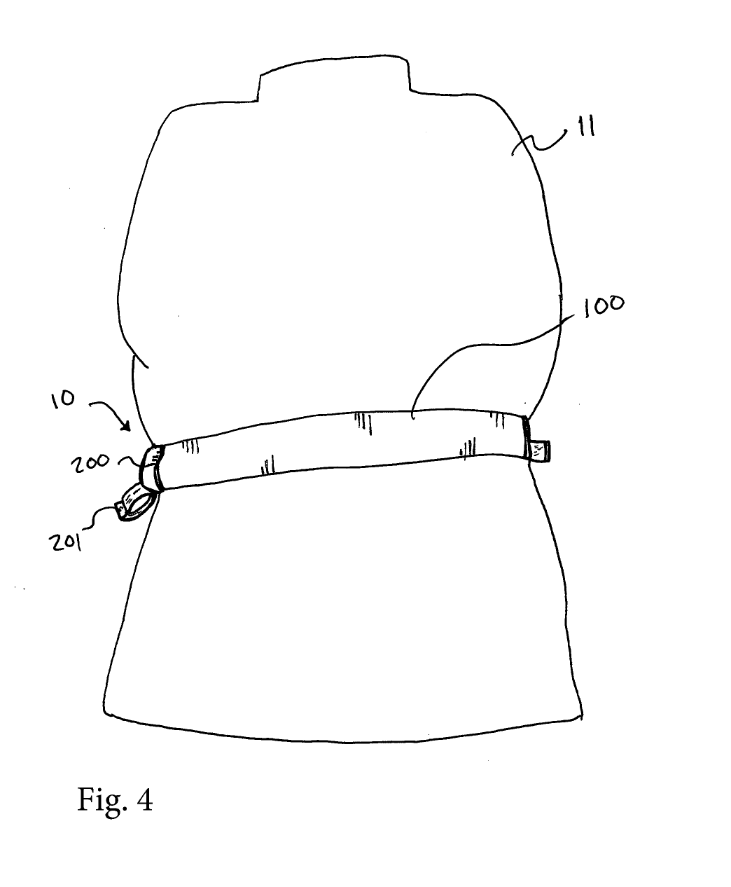

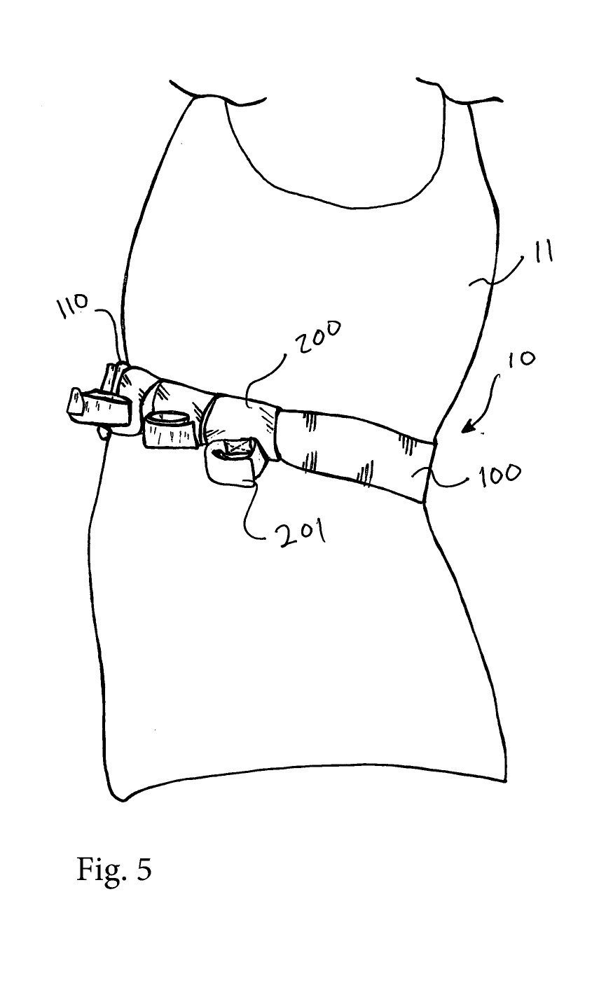

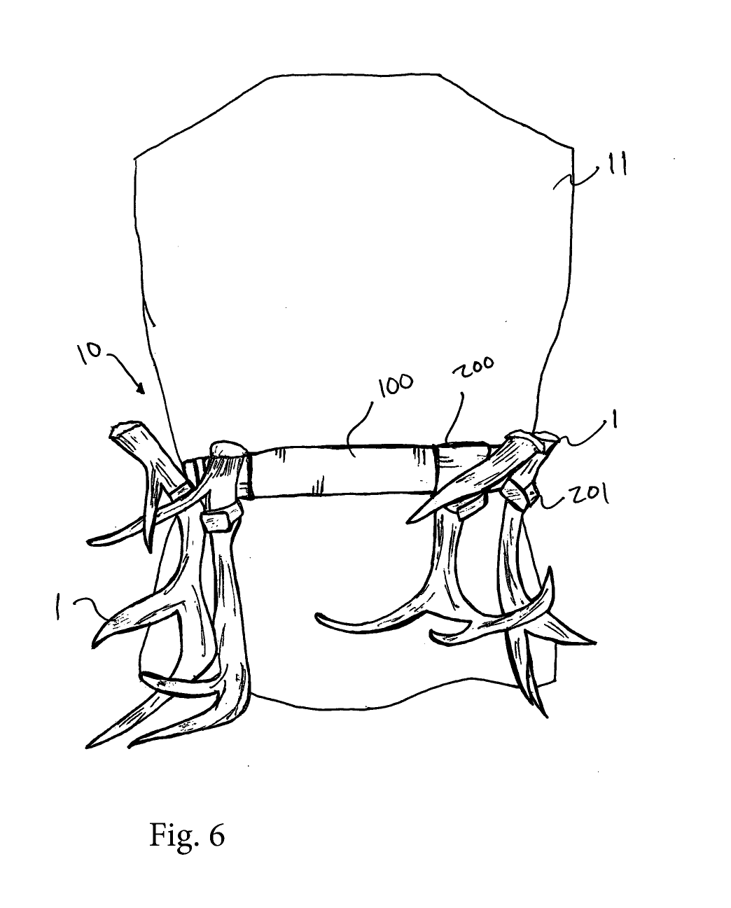

Referring now to FIG. 1-7 the shed attachment device of the present invention, generally referred to as device 10, is designed to allow for the universal affixation of shed antlers 1 or as they are commonly called, “sheds.” The shed attachment device 10 is adapted to be worn by a user as a strap or harness or integrated as a feature on a specifically designed garment 11 (FIGS. 3-6).

The device 10 includes a main strap 100. The main strap 100 having a width, a first end 101, and a second end 102 opposite the first end, the distance between the first end 101 and the second end 102 defining a length of the main strap 100. The first end 101 and the second end 102 include a clasp member 110, wherein the clasp member 110 can be coupled together to secure the device 10 around the middle section of the user's body. This clasp member 110 can be a buckle, clip, hook and loop, or other similar coupling means. The main strap 100 further includes an adjustment means 111, wherein the adjustment means 111 allows a user the ability to adjust the length of the main strap 100. The main strap 100 may include additional shoulder straps 112 extending upward from the main strap 100 and around the shoulders of the user. These additional shoulder straps 112 offer hanging support for the main strap 100 during use. The shoulder straps 112 may include an adjustment means 113 to adjust the length of the shoulder straps 112. The shoulder straps 112 may include an additional secondary clasp member 114 to be secured to the clasp member 110 of the main strap.

Preferably, this main strap 100 is comprised of nylon, polyester, or polypropylene webbing material or other similar material for its strength, durability and overall material properties.

A plurality of loops 200 are movably received around the width of the main strap 100. The loops 200 include a shed attachment portion 201. The shed attachment portion 201 being adjustable to affix various circumferences and dimensions of sheds 1. The loops 200 allow for movement along the length of the strap 100 allowing the user the ability to move retained sheds 1 to the desired position along the strap 100. It is preferred that the loops 200 be comprised of a material similar to the material used on the strap 100 for consistency in construction and durability.

In the preferred embodiment of the present invention, the shed attachment portion 201 is permanently affixed to the loop 200. This shed attachment portion portion 201 requires adjustment and flexibility to allow for the various diameters and shapes of retained sheds 1. Preferably, this shed attachment portion 201 is an elastic member retained with a clip or a hook and loop wrapping means, although other similar clasping means may be used.

In an alternate embodiment of the present invention (FIGS. 3-6), the main strap 100 is affixed to a garment 11, the garment 11 preferably being a vest easily worn over the top of existing clothes. The strap 100 affixed to the garment 11 using the clasp member 110. The strap 100 is comprised of a strong and durable material to withstand outdoor weather conditions and resist strain from affixed sheds 1.

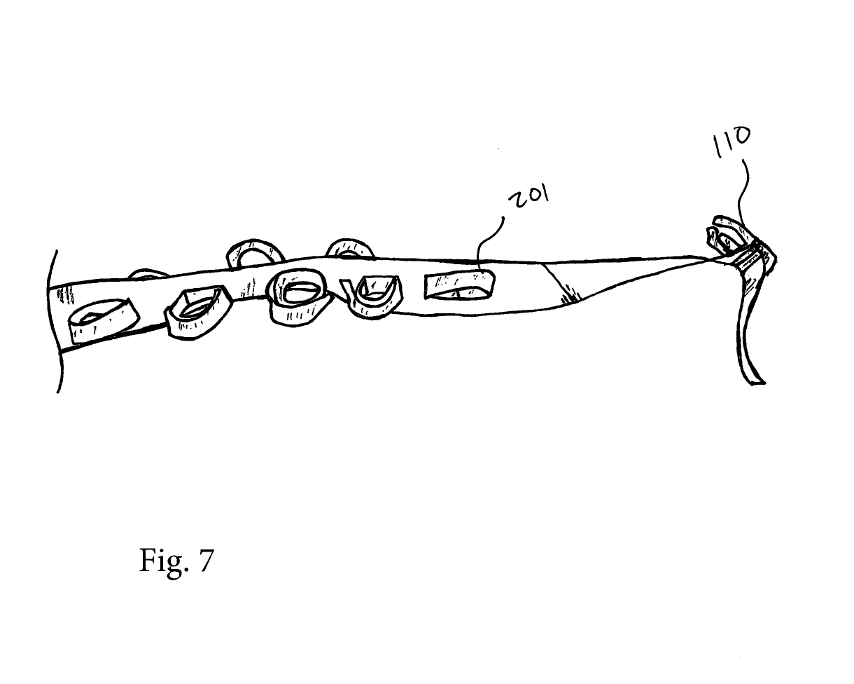

In an alternate embodiment of the present invention (FIG. 7), the main strap 100 may include a plurality of shed attachment portions 201 along its length as opposed to the loops.

In use, a user will secure a shed 1 within the clasp portion 201. The clasp portion 201 will securely wrap the shed 1 and keep the shed 1 in engagement with the strap 100. The loop 200 will allow the shed 1 to be moved to the desired location on the garment 11 along the strap 100.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the specification.

What is claimed is:

1. A shed antler retaining device, the device adapted to be worn by a user, the device comprising:
a main strap, the main strap having a width, a length and adapted to be worn around the middle section of a user's body, the main strap having a first end and second end, the first end and the second end adapted to be removably coupled to each other;
a plurality of loops, the loops received around the width of the main strap and movable across the length of the main strap; and
a shed attachment portion, the shed attachment portion affixed to a loop of the plurality of loops, the shed attachment portion encircling and securing a shed, wherein the attachment portion provides a grasping force to the shed for retaining the shed during carry.

2. A device as in claim 1, wherein the shed attachment portion is comprised of a hook and loop and material.

3. A device as in claim 1, wherein the shed attachment portion is comprised of an elastic material retained with a clasp.

4. A device as in claim 1, wherein the device is affixed to a garment.

5. A device as in claim 1, wherein the main strap is adjustable.

6. A device as in claim 1, wherein the main strap includes shoulder straps, the shoulder straps extending upward from the main strap an over the shoulders of a wearer.

7. A device as in claim 6, wherein the shoulder straps are adjustable.

8. A device as in claim 4, wherein the device is removably affixed to the garment.

9. A shed antler retaining device, the device adapted to be worn by a user, the device comprising:
a main strap, the main strap having a width, a length and adapted to be worn around the middle section of a user's body, the main strap having a first end and second end, the first end and the second end adapted to be removably coupled to each other;
a pair of shoulder straps, the shoulder straps extending upward from the main strap and over the shoulder's of the user, the shoulder straps adjustable and providing resting support for the device when worn; and
a plurality of loops, the loops received around the width of the main strap and movable across the length of the main strap, the loops having a shed attachment portion, the shed attachment portion encircling and securing a shed, wherein the attachment portion provides a grasping force to the shed for retaining the shed during carry.

10. A device as in claim 9, wherein the shed attachment portion is comprised of a hook and loop and material.

11. A device as in claim 9, wherein the shed attachment portion is comprised of an elastic material retained with a clasp.

12. A device as in claim 9, wherein the main strap is adjustable.
